(19) United States
(12) Patent Application Publication
(10) Pub. No.: US 2006/0088691 A1
(43) Pub. Date: Apr. 27, 2006

(54) Composite material used in packaging bag easily penetrated by a straw

(76) Inventor: Xuejun Zhong, Yuepu (CN)

Correspondence Address: LADAS & PARRY LLP, 224 SOUTH MICHIGAN AVENUE, SUITE 1600, CHICAGO, IL, 60604, US

(21) Appl. No.: 10/521,949

(22) PCT Filed: Jul. 22, 2003
(86) PCT No.: PCT/CN03/00588

§ 371 Date: Jan. 21, 2005

(30) Foreign Application Priority Data
Jul. 23, 2002 (CN) 02243013.X

(51) Int. Cl. B32B 3/10

(52) U.S. Cl. 428/138

(57) ABSTRACT

The present invention relates to a composite material used in beverage packaging bag easily penetrated by a straw. The composite material is made of more than two layers. A hole used for a straw is pre-punctured at least in one layer of the composite material. And at least one layer is not punctured so as to act as sealing layer. The present invention provides a composite material that is easy to be penetrated by a straw and has a reliable sealability. Moreover this kind of composite material is effective in cost and sanitary.

### TECHNICAL FIELD

The present invention relates to a composite material for packaging containers, especially for packaging containers which can be easily inserted into by a straw.

### BACKGROUND OF THE INVENTION

The ordinary composite material for soft package generally comprises printing layer, blocking layer, reinforcing layer and sealing layer, etc, and the specific structure is determined according to the requirements of the package. As the bi-directional stretch film is employed for the printing and reinforcing layers, the strength of the composite material is relatively high and cannot be easily torn or punched. It brings much trouble to the customers as the beverage spurt out while they tear open the composite material containers. In market, there exists at present a kind of packaging container having a pre-punched hole. It is to weld a sheet of sealing material which is easily to be punched, onto the interior surface of the pre-punched composite material. This type of packaging container is good in sealing and inserting. However, as this can only be carried out in special packaging/molding machine having a puncher and sealer, and additional subsidiary materials are needed. It is not easy to be popularized.

### DESCRIPTION OF THE INVENTION

The present invention is to provide a beverage for packaging container composite material which a straw can be easily inserted into and with reliable sealing. This composite material can solve the above-mentioned problems and can be widely applied safely and reliably.

The composite material of the present invention is compounded by using at least two layers of materials. Wherein at least one layer of the above-mentioned composite material has a pre-punched hole and at least one layer is used as sealing layer which has not been pre-punched.

According to one of the embodiments of the present invention, said composite material comprises two layers. Wherein the material of the first layer is one selected from the group consisting of bi-directional stretch polypropylene film, bi-directional stretch polyester film, bi-directional stretch nylon film, cellophane film and double-sided damp-proof cellophane film; and the material of the second layer is one selected from the group consisting of the copolymer and coextrusion multilayer polyethylene film including polyethylene film, EAA, EMAA, EVA and SURLYN etc. Wherein the pre-punched hole is on said first layer.

According to another embodiment of the present invention, the above-mentioned composite material comprises three layers: the material of the first layer is one selected from the group consisting of bi-directional stretch polypropylene film, bi-directional stretch polyester film, bi-directional stretch nylon film, cellophane film and double-sided damp-proof cellophane film; the material of the second layer is one selected from the group consisting of aluminum film, casting nylon film, polyvinyl alcohol film, EVOH film, bi-directional stretch polyester film, bi-directional stretch nylon film and vacuum aluminum plating polyester film; and the material of the third layer is one selected from the group consisting of the copolymer film and coextrusion multilayer polyethylene film including polyethylene film, EAA, EMAA, EVA and SURLYN etc. Wherein the pre-punched hole is on said first layer or first and second layers.

According to a third embodiment of the present invention, said composite material comprises four layers: the material of the first layer is one selected from the group consisting of bi-directional stretch polypropylene film, bidirectional stretch polyester film, bi-directional stretch nylon film, cellophane film and double-sided damp-proof cellophane film; the material of the second layer is one selected from the group consisting of aluminum film, casting nylon film, polyvinyl alcohol film, EVOH film, bi-directional stretch polyester film, bidirectional stretch nylon film and vacuum aluminum plating polyester film; the material of the third layer is one selected from the group consisting of aluminum film, casting nylon film, polyvinyl alcohol film, EVOH film, bi-directional polyester film, bi-directional stretch nylon film and vacuum aluminum plating polyester film; and the material of the fourth layer is one selected from the group consisting of copolymer and coextrusion multilayer polyethylene film including polyethylene film, EAA, EMAA, EVA and SURLYN etc. Wherein the pre-punched hole is on said first and second layers or on said first, second and third layers.

In the embodiment of the present invention, the pre-punched hole on the composite material may be in the form of round or round having intermittent cuts. It may also be any one of the crisscross, U-shape, V-shape and those shapes having intermittent cuts.

Besides, each two layers of the composite material are respectively connected by the adhesion agent, and form the adhesive layers.

In the composite material of the present invention, the pre-punching treatment is carried out at the specified position of the layer which is uneasily to be inserted. The size and shape to be punched will be adjusted according to the different requirement of the package and the external form and dimension of the straw, whereas no pre-punching treatment is made for the easily inserting sealing layer. In a result, it guarantees the intact packaging performance of the composite material and also the performance of easily inserting at the specified position can be retained. Being accomplished the particular pre-punching treatment on the final finished composite material, the product of the present invention can be applied on automatic packaging machines or container-making machines of any type without the need of any special auxiliary equipment.

The novel soft packaging composite material film easily inserted with straw possesses the following three characteristics:

1. Convenient to consumers—the layer that is uneasily to be inserted is the first layer of the packaging composite material. It has been pre-punched and the specified pre-punched area is circled out by printing. Consumers can easily find the area and use with ease.

2. Widely applied—The composite material easily inserted with straw can be applied to any packaging machines, handling in a conventional process without any subsidiary materials or auxiliary equipment, since the pre-punching treatment has been accomplished by the manufacturer of the composite material.

3. Safe and reliable hygiene—Since the pre-punching treatment is a physically mechanical treatment without addition of any harmful substance and the means of compounding has no difference with that of the regular compounding. Thus, hygiene is safe and reliable. In addition, as an internal sealing layer, it gives rise to the integration of the whole composite material. Therefore, the soft packaging composite material easily inserted with straw can effectively protect the beverage contained therein.

### FIGURE DESCRIPTION

FIG. 1 shows one embodiment of the present invention;

FIG. 2 shows another embodiment of the present invention;

FIG. 3 shows a third embodiment of the present invention;

FIG. 4 shows a fourth embodiment of the present invention;

FIG. 5 shows a fifth embodiment of the present invention;

FIG. 6 and 7 show the composite material with round pre-punched hole in the above-mentioned embodiment of the present invention;

FIG. 8 and 9 show the composite material with crisscross pre-punched hole in the above-mentioned embodiment of the present invention;

FIG. 10 and 11 show the composite material with U-shape pre-punched hole in the above-mentioned embodiment of the present invention;

FIG. 12 and 13 show the composite material with V-shape pre-punched hole in the above-mentioned embodiment of the present invention;

### EMBODIMENT

FIG. 1 shows side sectional view of the pre-punched area of the composite material of the first embodiment of the present invention. The composite material of the said embodiment comprises two layers: the first layer 16 is a printing layer; the second layer 19 is a sealing layer. There is an adhesive layer between the first layer 16 and the second layer 19. A pre-punched hole 12 is formed on the first layer 16.

In the first example of the present invention, the material of the first layer 16 of the composite material shown in FIG. 1 is bi-directional stretch polypropylene film, and the second layer 19 is polyethylene film.

In the second example of the present invention, the first layer 16 of the composite shown in FIG. 1 is bi-directional stretch polypropylene film as the printing layer, and the second layer 19 is vacuum aluminum plating/casting polypropylene film.

In the third example of the present invention, the material of the first layer 16 of the composite material shown in FIG. 1 is bi-directional stretch polyester film, and the second layer 19 is polyethylene film.

In the fourth example of the present invention, the first layer 1.6 of the composite shown in FIG. 1 is bi-directional stretch polyester film, and the second layer 19 is vacuum aluminum plating/casting polypropylene film.

In the fifth example of the present invention, the material of the first layer 16 of the composite material shown in FIG. 1 is bidirectional stretch nylon film, and the second layer 19 is polyethylene film.

In the sixth example of the present invention, the first layer 16 of the composite shown in FIG. 1 is bi-directional stretch nylon film, and the second layer 19 is casting polypropylene film.

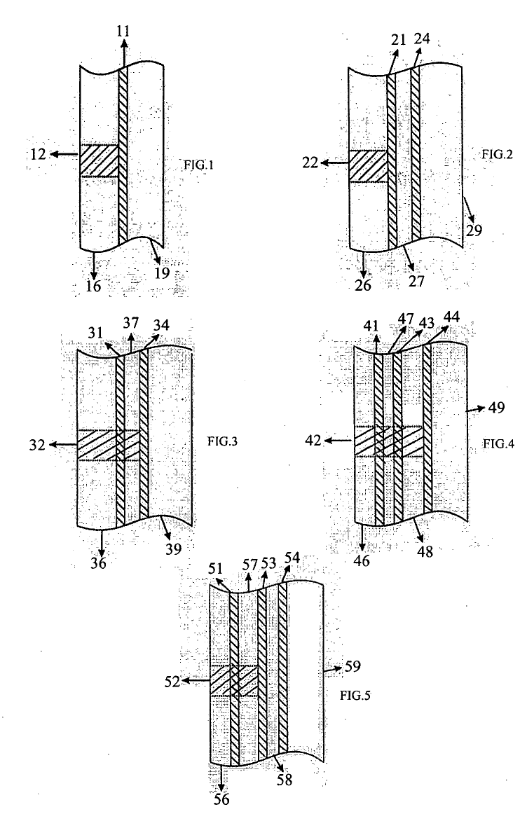

FIG. 2 shows side sectional view of the pre-punched area of the composite material of the second embodiment of the present invention. The composite material in said embodiment comprises three layers: the first layer 26 is a printing layer; the second layer 27 is a blocking layer; the third layer 29 is a sealing layer. There is an adhesive layer between the first layer 26 and the second layer 27, and an adhesive layer between the second layer 27 and the third layer 29. A pre-punched hole 22 is formed on the first layer 26.

In the seventh example of the present invention, the material of the first layer 26 of the composite material shown in FIG. 2 is bi-directional stretch polypropylene film, and the second layer 27 is aluminum film, then the third layer 29 is polyethylene film.

In the eighth example of the present invention, the material of the first layer 26 of the composite material shown in FIG. 2 is bi-directional stretch polyester film, and the second layer 27 is aluminum film, then the third layer 29 is polyethylene film.

In the ninth example of the present invention, the first layer 26 of the composite shown in FIG. 2 is bi-directional stretch polyester film, and the second layer 27 is aluminum film, then the third layer 29 is casting polypropylene film.

In the tenth example of the present invention, the material of the first layer 26 of the composite material shown in FIG. 2 is bi-directional nylon film, and the second layer 27 is aluminum film, then the third layer 29 is polyethylene film.

In the eleventh example of the present invention, the first layer 26 of the composite shown in FIG. 2 is bi-directional nylon film, and the second layer 27 is aluminum film, then the third layer 29 is casting polypropylene film.

FIG. 3 shows side sectional view of the pre-punched area of the composite material of the third embodiment of the present invention. The composite material in said embodiment comprises three layers: the first layer 36 is a printing layer; the second layer 37 is a reinforcing layer; the third layer 39 is a sealing layer. There is respectively an adhesive layer between the first layer 36 and the second layer 37, an adhesive layer between the second layer 37 and the third layer 39. A pre-punched hole 32 is formed on the first layer 36 and second layer 37.

In the twelfth example of the present invention, the material of the first layer -36 of the composite material shown in FIG. 3 is bi-directional stretch polypropylene film, and the second layer 37 is vacuum aluminum plating polyester film, then the third layer 39 is polyethylene film.

In the thirteenth example of the present invention, the material of the first layer 36 of the composite material shown in FIG. 3 is bi-directional stretch polyester film, and the second layer 37 is vacuum aluminum plating polypropylene film, then the third layer 39 is polyethylene film.

In the fourteenth example of the present invention, the material of the first layer 36 of the composite material shown in FIG. 3 is bi-directional stretch polyester film, and the second layer 37 is bi-directional stretch nylon film, then the third layer 39 is polyethylene film.

FIG. 4 shows side sectional view of the pre-punched area of the composite material of the fourth embodiment of the present invention. The composite material in said embodiment comprises four layers: the first layer 46 is a printing layer; the second layer 47 is a blocking layer; the third layer 48 is a reinforcing layer; and the fourth layer 49 is a sealing layer. There is respectively an adhesive layer between the first layer 46 and the second layer 47, the second layer 47 and the third layer 48, the third layer 48 and the fourth layer 49. A pre-punched hole 42 is formed on the first layer 46, the second layer 47 and the third layer 48.

In the sixteenth example of the present invention, the material of the first layer 46 of the composite material shown in FIG. 4 is bi-directional stretch polypropylene film, and the second layer 47 is aluminum film, the third layer 48 is bi-directional stretch nylon film and the fourth layer 49 is polyethylene film. There is respectively an adhesive layer 41 between the first layer 46 and the second layer 47, an adhesive layer 43 between the second layer 47 and the third layer 48, an adhesive layer 44 between the third layer 48 and the fourth layer 49.

In the seventeenth example of the present invention, the material of the first layer 46 of the composite material shown in FIG. 4 is bi-directional stretch polyester film, the second layer 47 is aluminum film, the third layer 48 is bi-directional stretch polyester film, and the fourth layer 49 is polyethylene film.

In the eighteenth example of the present invention, the material of the first layer 46 of the composite material shown in FIG. 4 is bi-directional stretch polyester film, the second layer 47 is aluminum film, the third layer 48 is bi-directional nylon film, and the fourth layer 49 is polyethylene film.

In the nineteenth example of the present invention, the first layer 46 of the composite shown in FIG. 4 is bi-directional stretch polyester film, and the second layer 47 aluminum film, the third layer 48 bi-directional stretch nylon film and the fourth layer 49 casting polypropylene film.

In the twentieth example of the present invention, the material of the first layer 46 of the composite material shown in FIG. 4 is bi-directional stretch nylon film, the second layer 47 is aluminum film, the third layer 48 is bidirectional stretch nylon film, and the fourth layer 49 is casting polypropylene film.

FIG. 5 shows side sectional view of the pre-punched area of the composite material of the fifth embodiment of the present invention. The composite material in said embodiment comprises four layers: the first layer 56 is a printing layer; the second layer 57 is a reinforcing layer; the third layer 58 is a blocking layer; and the fourth layer 59 is a sealing layer. There is respectively an adhesive layer between the first layer 56 and the second layer 57, an adhesive layer between the second layer 57 and the third layer 58, an adhesive layer between the third layer 58 and the fourth layer 59. A pre-punched hole 52 is formed on the first layer 56 and the second layer 57.

In the twenty first example of the present invention, the material of the first layer 56 of the composite material shown in FIG. 5 is bi-directional stretch polyester film, the second layer 57 is bi-directional stretch nylon film, the third layer 58 is aluminum film, and the fourth layer 59 is polyethylene film.

In the twenty-second example of the present invention, the first layer 56 of the composite shown in FIG. 5 is bidirectional stretch polyester film, and the second layer 57 bi-directional stretch nylon film, the third layer 58 aluminum film and the fourth layer 59 casting polypropylene film.

In the twenty-third example of the present invention, the first layer 56 of the composite shown in FIG. 5 is bi-directional stretch nylon film as the printing layer, and the second layer 57 bidirectional stretch nylon film, the third layer 58 aluminum film and the fourth layer 59 casting polypropylene film.

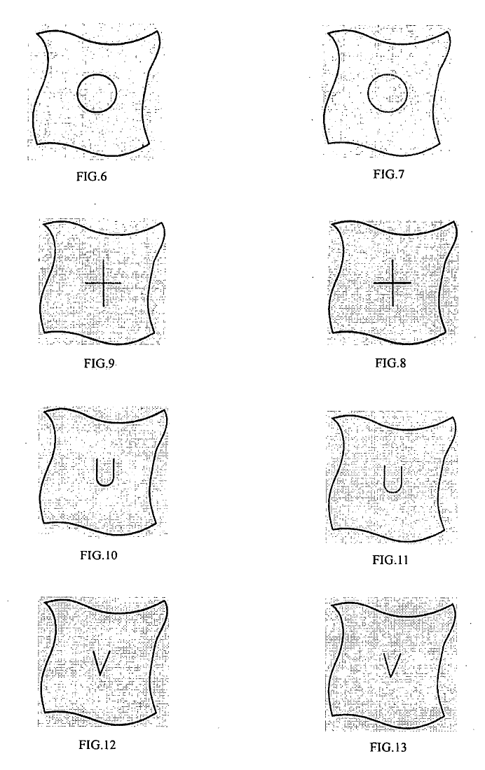

The pre-punched holes in all the above-mentioned examples of the present invention may be in the forms of round or shapes other than round. The method which can be used for forming the hole may be full size cutting or discontinuously cutting, for example, fully circular cutting shown in FIG. 6, discontinuously circular cutting shown in FIG. 7, crisscross cutting shown in FIG. 8, discontinuously crisscross cutting shown in FIG. 9, U-shape cutting shown in FIG. 10, discontinuously U-shape cutting shown in FIG. 11, V-shape cutting shown in FIG. 12 and discontinuously V-shape cutting shown in FIG. 13. Any variations of the shape of the pre-punched hole and method forming the same will not depart from the basic concept of the present invention and ought to be within the protection scope of the present invention.

The pre-punched composite material according to the present invention is a suitable material for making packaging containers for beverage. The description hereinabove in regard to the material does not constitute a limitation to the protection scope of the invention. Any modifications and variations made according to the above-mentioned basic concept and spirit are intended to be included within the protection scope of the present invention as herein defined in the appended claims.

1-29. (canceled)

30. A composite material comprising at least two layers of materials, and having an adhesive layer between the at least two layers of materials wherein at least a first layer of said composite material has a pre-punched perforation defining an opening that is formed by the penetration of an object through said layers, and at least one layer is a sealing layer.

31. The composite material according to claim 30 wherein said composite material comprises two layers of materials and said adhesive layer is between said two layers of material; the material of the first layer is one selected from the group consisting of bidirectional stretch polypropylene film, bi-directional stretch polyester film, bidirectional stretch nylon film, cellophane film, and double-sided damp-proof cellophane film; and the material of a second layer is one selected from the group consisting of the copolymer and coextrusion multilayer polyethylene film including polyethylene film, EAA, EMM, EVA, and SURLYN.

32. The composite material according to claim 30 wherein said composite material comprises three layers and there is a first adhesive layer between the first layer and a second layer, and a second adhesive layer between the second layer and a third layer; the material of said layer is one selected from the group consisting of bi-directional stretch polypropylene film, bi-directional stretch polyester film, bi-directional stretch nylon film, cellophane film, and double-sided damp-proof cellophane film; the material of said second layer is one selected from the group consisting of aluminum film, casting nylon film, polyvinyl alcohol film, EVOH film, bi-directional stretch polyester film, bidirectional stretch nylon film, and vacuum aluminum plating polyester film; and the material of said third layer is one selected from the group consisting of the copolymer films and coextrusion multilayer polyethylene film including polyethylene film, and EM, EMAA, EVA, SURLYN.

33. The composite material according to claim 30 wherein said composite material comprises four layers and there is a first adhesive layer between the first layer and a second layer, a second adhesive layer between the second layer and a third layer, and a third adhesive layer between the third layer and a fourth layer; the material of said first layer is one selected from the group consisting of bi-directional stretch polypropylene film, bidirectional stretch polyester film, bidirectional stretch nylon film, cellophane film, and double-sided damp-proof cellophane film; the material of said second layer is one selected from the group consisting of aluminum film, casting nylon film, polyvinyl alcohol film, EVOH film, bidirectional stretch polyester film, bidirectional stretch nylon film, and vacuum aluminum plating polyester film; the material of said third layer is one selected from the group consisting of aluminum film, casting nylon film, polyvinyl alcohol film, EVOH film, bi-directional polyester film, bidirectional stretch nylon film, and vacuum aluminum plating polyester film; and the material of said fourth layer is one selected from the group consisting of copolymer and coextrusion multilayer polyethylene film including polyethylene film, EM, EMAA, EVA, and SURLYN.

34. The composite material according to claim 30 wherein said pre-punched perforation is fully cut along the entire length of the perforation and has a shape selected from the group consisting of circular, crisscross, U-shape, and V-shape.

35. The composite material according to claim 30 wherein said pre-punched perforation is discontinuously cut and has a shape selected from the group consisting of circular, crisscross, U-shape and V-shape.

36. The composite material according to claim 31 wherein the material of said first layer is a bi-directional stretch polypropylene film where the pre-punched perforation is formed; and the material of said second layer is a polyethylene film and used as the sealing layer.

37. The composite according to claim 31 wherein the first layer is a bi-directional stretch polyester film where the pre-punched perforation is formed, and the second layer is a polyethylene film and used as the sealing layer.

38. The composite material according to claim 31 wherein the material of said first layer is a bidirectional stretch nylon film where the pre-punched perforation is formed; and the material of said second layer is a polyethylene film and used as the sealing layer.

39. The composite material according to claim 32 wherein the material of said first layer is a bi-directional stretch polypropylene film where the pre-punched perforation is formed; and said second layer is an aluminum film and said third layer is a polyethylene film, both the second and third layers being used as the sealing layer.

40. The composite material according to claim 32 wherein the material of said first layer is a bidirectional stretch polyester film where the pre-punched perforation is formed; and said second layer is an aluminum film and said third layer is a polyethylene film, both the second and third layers being used as the sealing layer.

41. The composite material according to claim 32 wherein the material of said first layer is a bidirectional stretch nylon film where the pre-punched perforation is formed; and said second layer is an aluminum film and said third layer is a polyethylene film, both the second and third layers being used as the sealing layer.

42. The composite material according to claim 32 wherein the material of said first layer is a bidirectional stretch polypropylene film, the second layer is a vacuum aluminum plating polyester film, and the third layer is a polyethylene film; wherein on said first layer and second layer a pre-punched perforation is formed; and said third layer is used as the sealing layer.

43. The composite material according to claim 32 wherein the material of said first layer is a bi-directional stretch polyester film, the second layer is a vacuum aluminum plating polyester film, and the third layer is a polyethylene film; wherein on the said first layer and the said second layer a pre-punched perforation is formed; and said third layer is used as the sealing layer.

44. The composite material according to claim 32 wherein the material of said first layer is a bidirectional stretch polyester film, the second layer is a bidirectional stretch nylon film, and the third layer is a polyethylene film; wherein on said first layer and said second layer a pre-punched perforation is formed; and said third layer is used as the sealing layer.

45. The composite material according to claim 33 wherein the material of said first layer is a bi-directional stretch polypropylene film, the second layer is an aluminum film, the third layer is a bi-directional stretch nylon film, and the fourth layer is a polyethylene film; wherein on said first layer, said second layer and said third layer a pre-punched perforation is formed; and said fourth layer is used as the sealing layer.

46. The composite material according to claim 33 wherein the material of said first layer is a bidirectional stretch polyester film, the second layer is an aluminum film, the third layer is a bidirectional stretch polyester film, and the fourth layer is a polyethylene film; wherein on said first layer, second layer and third layer a pre-punched perforation is formed; and said fourth layer is used as the sealing layer.

47. The composite material according to claim 33 wherein the material of said first layer is a bi-directional stretch polyester film, the second layer is an aluminum film, the third layer is a bi-directional stretch nylon film, and the fourth layer is a polyethylene film; wherein on said first layer, second layer and third layer a pre-punched perforation is formed; and said fourth layer is used as the sealing layer.

48. The composite material according to claim 33 wherein the material of said first layer is a bidirectional stretch polyester film, the second layer is a bidirectional stretch nylon film, the third layer is an aluminum film, and the fourth layer is a polyethylene film; wherein on said first layer and second layer a pre-punched perforation is formed; and said third layer and fourth layer are used as the sealing layer.
